(19) United States
(12) Patent Application Publication
(10) Pub. No.: US 2015/0139250 A1
(43) Pub. Date: May 21, 2015

(54) SYNCHRONIZED NETWORK STATISTICS COLLECTION

(71) Applicants: Hei Tao Fung, Fremont, CA (US); David Liu, Livemore, CA (US); James Liao, Palo Alto, CA (US)

(72) Inventors: Hei Tao Fung, Fremont, CA (US); David Liu, Livemore, CA (US); James Liao, Palo Alto, CA (US)

(73) Assignee: Pica8, Inc., Palo Alto, CA (US)

(21) Appl. No.: 14/082,369

(22) Filed: Nov. 18, 2013

(51) Int. Cl. H04L 12/26

(52) U.S. Cl. CPC H04L 43/067
USPC 370/503

(57) ABSTRACT

A system, method, and computer program product are provided for collecting a snapshot of the statistics of a computer network. The devices of the network that provide the statistics synchronize their clocks to a time source. The statistics collector can request the devices to read their counters at a specified time. The counter values are stored and time-stamped on the devices. The statistics collector can later retrieve the stored counter values from the devices and correlate the statistics by the time-stamps.

### FIELD OF THE INVENTION

This application relates to computer networking and more particularly to collecting a snapshot of statistics on a computer network.

### BACKGROUND

A computer network comprises various interconnected network devices. Some of them are the sources and destinations of data packets. Some of them are networking elements responsible for transporting data packets from sources to destinations. In this era of computer virtualization, computers may also implement networking elements inside for switching data packets among the virtual machines. Network statistics provide visibility into how the computer network fares in forwarding data packets and provide data points for improving the network performance. For example, in a data center network, the flows of data packets congested at a path can be re-distributed over less-congested alternate paths to reduce latency and packet loss.

There are a number of network statistics collection mechanisms. One example is using Simple Network Management Protocol (SNMP). A network statistics server may use SNMP to retrieve counter values on the network devices. A drawback of existing network statistics collection mechanisms is lack of precise timing on collecting the counter values as well as lack of timing information about the counter values collected on the many network devices. For example, switch A may provide its port counter values, and switch B may provide its own. However, if switch A's counter values are collected at a time different from the time that switch B collects its own, it is difficult to create a snapshot of network statistics or interpret the relationship between switch A's counter values and switch B's counter values. In other words, we need a way to synchronize the collection of network statistics among the many network devices and correlate the counter values collected at the many network devices so that a network statistics server can create a snapshot of network statistics.

### SUMMARY OF THE INVENTION

We disclose herein a system, method, and computer program product for synchronizing statistics collection on network devices so that the collected network statistics can represent a snapshot of the statistics of the network. The network devices that provide the statistics synchronize their clocks to a common time source. The network statistics server can request the network devices to read their counters at a specified time with reference to their synchronized clocks. The counter values are stored and time-stamped on the network devices. The network statistics server can later retrieve the stored counter values from the network devices and correlate the counter values by the time-stamps.

### BRIEF DESCRIPTION OF THE DRAWINGS/FIGURES

The present disclosure will be understood more fully from the detailed description that follows and from the accompanying drawings, which however, should not be taken to limit the disclosed subject matter to the specific embodiments shown, but are for explanation and understanding only.

FIG. 1 illustrates an exemplary deployment scenario of the present invention.

FIG. 2 illustrates an implementation of the present invention on a network device.

FIG. 3 illustrates an implementation of the present invention on a network statistics server.

FIG. 4 illustrates an implementation of messaging between a network device and a network statistics server.

FIG. 5 illustrates an implementation of a database of counter values.

### DETAILED DESCRIPTION OF THE INVENTION

A computer network comprises network devices. The computer network herein can be a physical network, such as one using switches and routers to connect computers and appliances together, or a logical network, such as one built with VxLAN (Virtual Extensible Local Area Network) technologies where computers and appliances are connected via logical connections overlaid on physical connections provided by switches and routers. Computers and appliances herein include physical computers and appliances and also virtualized machines (VMs) and virtualized appliances (VAs). A physical computer hosting VMs may have a virtual switch, which is a software module capable of forwarding data packets among the VMs and the network devices outside the physical computer. Appliances herein refer to computers, servers, or machines that provide applications and services. Network devices herein can refer to physical switches and routers, virtual switches and routers, physical machines and appliances, and virtualized machines and appliances. Our main concern is about collecting a snapshot of counter values on the network devices to enable, for example, network performance analysis and traffic engineering. Some examples of network device counters include the number of ingress packets, the number of egress packets, the number of bytes of ingress packets, the number of bytes of egress packets, the number of packets dropped due to congestion, the number of bytes of egress packets of a specific flow, etc. Some counters may be maintained in hardware, for example, on a switch chip and on a NIC (Network Interface Card). Some counters may be maintained in software, for example, on an operating system IP (Internet Protocol) stack. Each network device maintains its own set of counters. In practice, some counters are standardized for some types of network devices. Ethernet MIB (Management Information Base) is an example. Some counters may be unique to some network devices such as the number of packets dropped due to fullness of queues.

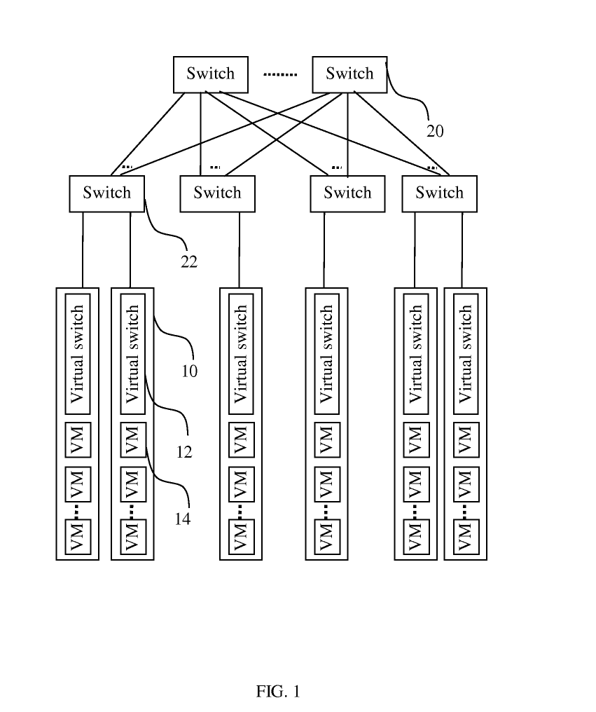

FIG. 1 shows an exemplary deployment scenario of the present invention. It is a network with a tier of spine switches 20 and a tier of leaf switches 22 connecting a tier of computers 10 together. A computer 10 comprises a virtual switch 12 connecting virtual machines 14 and a leaf switch 22 together.

In the present invention, we suppose that there is a network statistics server interested in gathering the counter values from the network devices of a computer network to provide useful applications to network administrators. The network statistics server may comprise software executed on a physical computer or software executed on a virtual machine. The network statistics server can be one of the network devices in the computer network or a separate device outside the computer network. In the latter case, the network statistics server may communicate to the network devices via the computer network or communicate to the network devices via a separate network. There may be more than one network statistics servers gathering counter values from the same network devices.

The method disclosed herein can be described from the viewpoint of a network device and from the viewpoint of a network statistics server. The method comprises the following three steps. Firstly, the clocks of the network statistics server and the network devices are to be synchronized to a common time source. Secondly, the network statistics server requests the network devices to read their counter values at a specified time. A network device reads its counters at the specified time and associates a time-stamp to the counter values. The time-stamp is related to the specified time for reading the counters. Thirdly, the network devices provide to the network statistics server the set of counter values along with its corresponding time-stamp, i.e., in other words, the set of time-stamped counter values. The network statistics server may request the network devices to do so; alternatively, the network devices may do so as a result of the second step.

The three steps may not always be executed sequentially. Also, each of the three steps can be repeated multiple times. For example, the network devices may read their counter values multiple times at various specified time. Therefore, there can be multiple sets of time-stamped counter values before the third step.

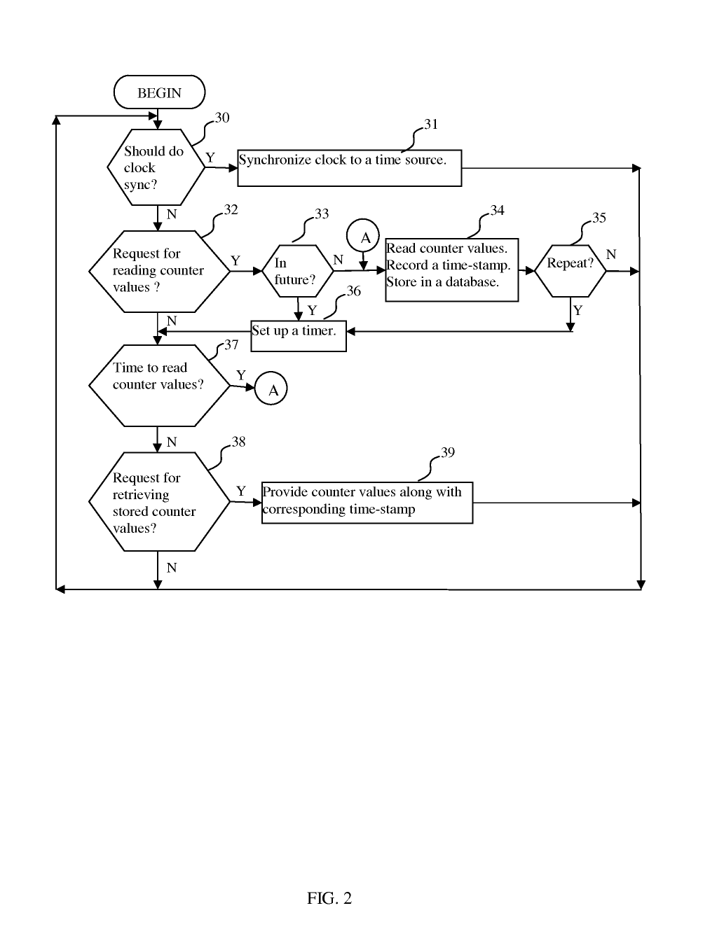

FIG. 2 illustrates one embodiment of the method from the viewpoint of a network device. Step 30 determines whether synchronizing its clock to a time source is necessary. The decision may be based on a check on the time difference between the clock and the time source. The decision may also be based on a request message received from a network statistics server. The decision may also be based on a periodic timer expiry. In step 31, the network device synchronizes its clock a time source. The time source may be configured by a network administrator. The time source may also be specified by a network statistics server. The time source may also be automatically obtained from a server during the boot-up of the network device. The time source should be accessible and common to the network devices and the network statistics server. The time source can be a clock on the network statistics server itself. Clock synchronization may involve exchanging messages between the network device and the time source. One implementation of the clock synchronization is NTP (Network Time Protocol).

Step 32 determines whether a network statistics server has requested reading its counters at specified time. Step 33 determines whether the specified time is in the future. The specified time is compared to the value of the clock of the network device. When the specified time represents now or the past, step 34 is executed. When the specified time represents a future time, step 36 is executed to set up a timer that will expire at the specified time. The timer expiry will make step 37 to take the branch to step 34.

In step 34, the network device reads its counters. The set of counters to be read may be configured by a network administrator. They may also be decided by the programmer. They may also be specified by the network statistics server via a request message. The network device assigns a time-stamp to the set of counter values. The time-stamp is related to the specified time for reading the set of the counter values. In one implementation, the time-stamp may represent exactly the specified time. In another implementation, the time-stamp may represent the actual time when reading the set of the counter values starts. In yet another implementation, the time-stamp may represent the actual time when reading the set of the counter values ends.

In step 34, the network device may store the set of time-stamped counter values in a database. The database may be a data store common and accessible to all network devices. For example, the database may reside on the network statistics server. Supporting many network devices updating a common database will require a high-performance database. In another implementation, the database may be local to the network device, and each network device maintains its own database. The database may store multiple sets of time-stamped counter values such that a network statistics server may request to retrieve a specified set of time-stamped counter values by specifying a time-stamp.

Step 35 determines whether the network device should repeat reading the counters. The decision may be based on whether the network statistics server has requested so. The decision may also be based on a default setting on the network device.

Step 37 determines whether it is time to read the counters. A timer expiry set up to trigger reading the counters may lead to step 34. The timer may have been set up by a request from a network statistics server or by a default configuration.

Step 38 determines whether the network device should send the counter values to a network statistics server. The decision may be based on a request received from a network statistics server to retrieve the counter values. The decision may also be based on a request from a network statistics server to read the counter values a specified time.

In step 39, the network device sends to the network statistics server counter values along with corresponding time-stamps. The network device may send a set, multiple sets, a specified set, multiple specified sets, a specified subset, or multiple specified subsets of time-stamped counter values. The network statistics server may provide a specified time-stamp as well as counter selection criteria in a request to the network device.

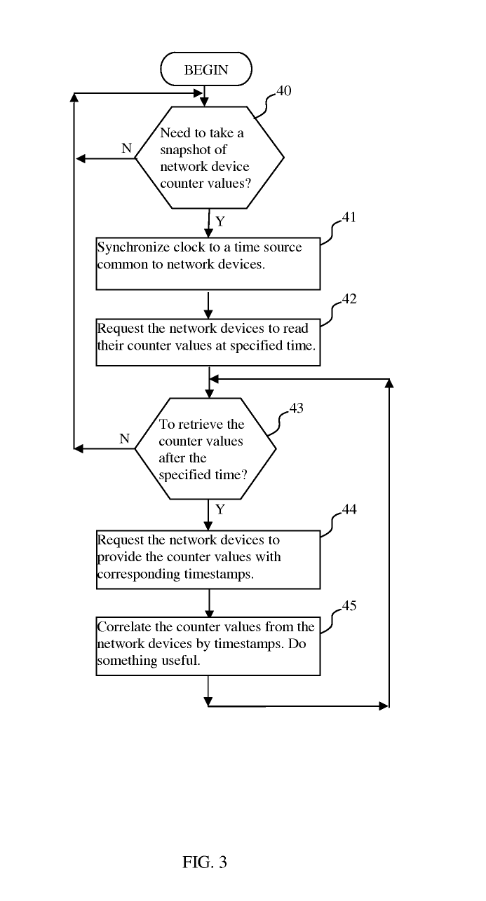

FIG. 3 illustrates one embodiment of the method from the viewpoint of a network statistics server. Step 40 determines whether there is a need to take a snapshot of the network statistics. The decision may be based on a network administrator requirement or a software application requirement. In step 41, the network statistics server makes sure that its clock is synchronized to a common time source to which the network devices synchronize their clock. There can be various implementations for the time source. In one implementation, the time source is actually the clock of the network statistics server. In another implementation, the time source is a clock on a separate time server such as an NTP server. The network statistics server may periodically check with the time source. In one implementation, the network statistics server requests the network devices to synchronize their clocks to the time source. In another implementation, the network statistics server specifies the time source to the network devices and let the network devices handle the clock synchronization autonomously. In yet another implementation, a network administrator, manually or via a script, configures the time source on the network statistics server and the network devices, and the network statistics server and the network devices handle the clock synchronization autonomously.

In step 42, the network statistics server requests the network devices to read their counter values at a specified time. The request may specify the specified time larger than the current value of the clock so as to schedule reading the counters in the future. The request may also specify the set of counters to be read. The request may also specify the number of times to repeat reading the counters at a specified interval.

The request may specify the specified time to be smaller than the current value of the clock so as to mean reading the counters as soon as possible. However, that may cause the network devices to read their counters at slightly different moment because the network devices will likely receive the request not in the same moment. That would hamper the ability of creating a snapshot of the network statistics. Having the clocks of the network statistics server and the network devices synchronized and scheduling reading counter values at a future time with reference to their synchronized clocks enable creating a snapshot of the network statistics.

Step 43 determines whether there is a need to retrieve the counter values from the network devices now. If the counter values are not yet available because they are to be read in a specified future time, then branch to step 40 should be taken. Also, the network statistics server may wait for multiple sets of counter values read at various specified time to be available on the network devices before retrieving those sets of time-stamped counter values. For example, the network statistics server may be interested in a histogram of the counter values. To build the histogram needs multiple sets of time-stamped counter values.

In step 44, the network statistics server retrieves counter values read at some specified time from the network devices. The network statistics server may specify what counter values among a full set of counter values read at a specified time on the network devices. The network statistics server may also qualify the request by a specified time-stamp which corresponds to a specified time at which the network devices have read their counters. In other words, the network statistics server may retrieve a subset of counter values from what have been stored on the network devices that read their counters at various specified time.

In step 45, the network statistics server forms a snapshot of the network statistics, which are the counter values of the network devices in the same moment. The network statistics server uses the retrieved time-stamped counter values corresponding to a specified time-stamp to form the snapshot. The snapshot may be used for purposes such as traffic analysis and traffic engineering.

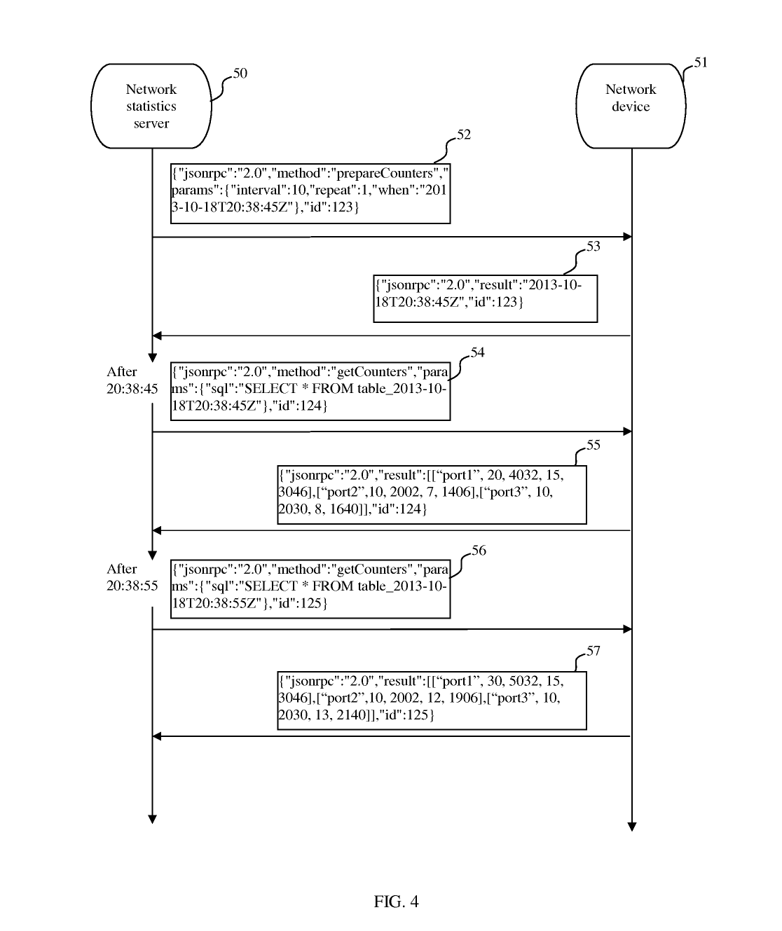

FIG. 4 illustrates one embodiment of messaging between a network statistics server and a network device. The messages are expressed in JSON-RPC (JavaScript Object Notation—Remote Procedure Call) 2.0 format. Message 52 is a request from network statistics server 50 to network device 51 for reading counters at 20:38:45 on Oct. 18, 2013 and repeating it one time after ten seconds. In general, the ‘prepareCounters’ method accepts ‘interval’, ‘repeat’, and ‘when’ arguments. The ‘when’ argument specifies when the counters are to be read. A value greater than the current value of the clock refers to a specified time in the future. A value smaller than the current value of the clock refers to now. The ‘repeat’ argument specified the number of times repeating reading the counter values. The ‘interval’ argument specifies the interval between repeating reading the counter values. The ‘prepareCounters’ method may also accept an argument specifying what counter values are to be read.

Message 53 is a response from the network device 51. The ‘result’ field reveals the time-stamp corresponding to reading the counter values at the specified time in message 52. The time-stamp value is related to the specified time. The time-stamp value may represent the specified time exactly. Alternatively, the time-stamp value may represent the actual time of reading the counters. The return time-stamp value facilitates the network statistics server 50 to be able to retrieve the time-stamped counter values at an appropriate time.

Message 54 is a request for retrieving a set of counter values with corresponding time-stamp 2013-10-18T20:38:45Z. The message should be generated after the set of counter values becomes available, i.e., after 20:38:45 of Oct. 18, 2013. The ‘getCounters’ method accepts an ‘sql’ argument. The ‘sql’ argument represents an SQL (Structured Query Language) statement. Message 54 retrieves all columns of the ‘table_{—}2013-10-18T20:38:45Z’ table in a relational database on the network device 51 which stores the sets of counter values read at various specified time. The specified time-stamp of the wanted set of counter values is embedded in the table name in the SQL statement.

Message 55 provides an array of arrays representing the wanted set of counter values retrieved from the relational database.

Message 56 is a request for retrieving a set of counter values with corresponding time-stamp 2013-10-18T20:38:55Z. The message should be generated after the set of counter values becomes available, i.e., after 20:38:55 of Oct. 18, 2013, ten seconds after 20:38:45 of Oct. 18, 2013. Message 57 provides an array of arrays representing the wanted set of counter values retrieved from the relational database.

A network device may not be able to read its counter values precisely at the specified time. It is because reading counter values may take non-negligible time and cannot be done instantly in practice. Sometimes, the imprecision can be ignored if it is a small value off the specified time. When the imprecision cannot be ignored, it is better that the network device provides counters values of the specified time via interpolation of counter values of two readings, once prior to the specified time and once after the specified time. In one exemplary embodiment, the network device reads a set of counter values b₀, b₁, . . . , b_{N} for counter 0, 1, N, respectively, starting at t_{b}(0). Let t_{b}(N) be the time immediately after reading b_{N}. t_{b}(N) must be smaller than the specified time t. Then after time t, the network device reads a set of counter values a₀, a₁, . . . , a_{N} for counter 0, 1, . . . , N, respectively, starting at tₐ(0). Let tₐ(N) be the time after reading a_{N}. Then the network device can interpolate the counter value c(i) of the specified time t for counter i, for i=0, 1, . . . , N. Firstly, t_{b}(i)=t_{b}(0)+((t_{b}(N)−t_{b}(0))×i÷N). Secondly, tₐ(i)=tₐ(0)+((tₐ(N)−tₐ(0))×i÷N). Finally, c(i)=bᵢ+((aᵢ−bᵢ)×(t−t_{b}(i))÷(tₐ(i)−t_{b}(i))). To minimize the estimation error resulting from interpolation, t_{b}(N) and tₐ(0) should be as close to the specified time t as possible.

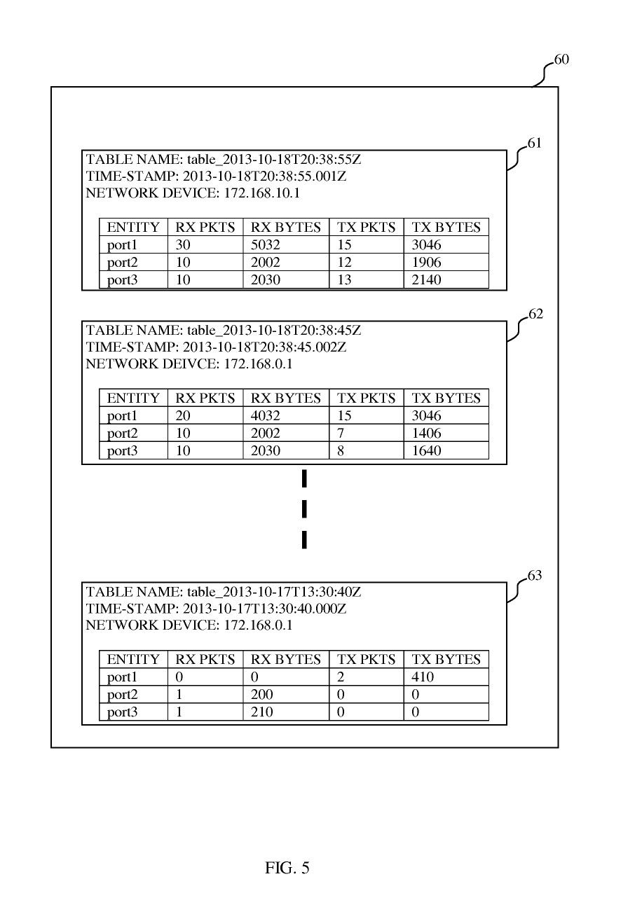

FIG. 5 illustrates one embodiment of a database on a network device for storing multiple sets of counter values read at various specified time. The database comprises a relational database with column keys of ‘ENTITY’, ‘RX PKTS’, ‘RX BYTES’, ‘TX PKTS’, and ‘TX BYTES’. There are multiple tables. Each table represents a set of time-stamped counter values read at a specified time. The network device may remove old tables from the database when the database grows beyond a limit. For example, the limit is a threshold on the number of tables. When the threshold is exceeded, table 63, which the oldest table then, is deleted. In database 60, a time-stamp is associated to the whole table. In another embodiment, a time-stamp is associated to each row of a table.

The database is not required on a network device if the network device sends over the time-stamped counter values to the network statistics server upon reading the counters. In that case, the network statistics server should have such a database to buffer up the counter values provided by various network devices. Also, the network statistics server may time-stamp the counter values provided by various network devices. It is preferred, however, that a database is present on the network device so that there can be a number of sets of counter values read at various specified time and time-stamped by the network device before the network statistics server retrieves the counter values interested.

The database can be implemented with other types of data structures such as a key-value pair store, a subject-predicate-object triple store, and a hash table. The database may also store statistics derived from the counter values read from the counters. For example, it may store a transmission packet rate derived from the difference of two numbers of transmitted packets over the difference in two corresponding specified time values.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for enabling a network statistics server to collect a snapshot of counter values on a plurality of network devices, the method executed on each of the plurality of network devices, the method comprising:
synchronizing a clock to a time source common to said plurality of network devices;
reading device counter values at a specified time with reference to said clock,
wherein said specified time is specified by said network statistics server,
wherein said device counter values are time-stamped with a time-stamp,
wherein said time-stamp is related to said specified time; and
providing said device counter values to said network statistics server.

2. The method as in claim 1, wherein said device counter values along with said time-stamp are stored in a database as one of at least one set of time-stamped device counter values.

3. The method as in claim 2, wherein an old set of said at least one set of time-stamped device counter values is removed from said database when said database grows beyond a limit.

4. The method as in claim 2, wherein said database can provide a set of device counter values, of said at least one set of time-stamped device counter values, the set of device counter values corresponding to a specified time-stamp, to said network statistics server when said network statistics server requests with said specified time-stamp.

5. The method as in claim 2, wherein said database can provide statistics derived from said at least one set of time-stamped device counter values to said network statistics server.

6. The method as in claim 2, wherein said database is on said network statistics server.

7. The method as in claim 1, wherein said reading device counter values at a specified time comprises:
reading a first set of said device counter values before said specified time;
reading a second set of said device counter values after said specified time; and
interpolating said device counter values of said specified time based on said first set of said device counter values and said second set of said device counter values.

8. The method as in claim 1, and further comprising enabling said network statistics server to specify from which device counters to read said device counter values.

9. The method as in claim 1, wherein said time-stamp exactly represents said specified time.

10. The method as in claim 1, wherein said time-stamp represents an actual time of reading said device counter values at said specified time.

11. The method as in claim 1, wherein said time source is said network statistics server.

12. A method for collecting a snapshot of counter values on a plurality of network devices, the method implemented on a network statistics server, the method comprising:
synchronizing a clock to a time source to which said plurality of network devices synchronize their clocks;
causing each of said plurality of network devices to read device counter values at a specified time with reference to said clock, the device counter values being time-stamped with a time-stamp, wherein said time-stamp is related to said specified time; and
causing said each of said plurality of network devices to provide said device counter values.

13. The method as in claim 12, wherein said each of said plurality of network devices stores said device counter values along with said time-stamp in a database as one of at least one set of time-stamped device counter values.

14. The method as in claim 13, wherein an old set of said at least one set of time-stamped device counter values is removed from said database when said database grows beyond a limit.

15. The method as in claim 13, wherein said database can provide a set of device counter values, of said at least one set of time-stamped device counter values, the set of device counter values corresponding to a specified time-stamp, to said network statistics server when said network statistics server requests with said specified time-stamp.

16. The method as in claim 13, wherein said database can provide statistics derived from said at least one set of time-stamped device counter values to said network statistics server.

17. The method as in claim 13, wherein said database is on said network statistics server.

18. The method as in claim 12, wherein a network device, of said plurality of network devices, may provide said device counter values of said specified time using steps comprising:
reading a first set of said device counter values before said specified time;
reading a second set of said device counter values after said specified time; and
interpolating said device counter values of said specified time based on said first set of said device counter values and said second set of said device counter values.

19. The method as in claim 12, and further comprising specifying which device counters said plurality of network devices are to read said device counter values from.

20. The method as in claim 12, wherein said time-stamp represents exactly said specified time.

21. The method as in claim 12, wherein said time-stamp represents an actual time of reading said device counter values at said specified time.

22. The method as in claim 12, and further comprising causing said plurality of network devices to synchronize their clocks to said time source.
